(19) United States
(12) Patent Application Publication
(10) Pub. No.: US 2008/0048610 A1
(43) Pub. Date: Feb. 28, 2008

(54) BATTERY CHARGER

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/509,776

(22) Filed: Aug. 25, 2006

(51) Int. Cl. H02J 7/00

(52) U.S. Cl. 320/107

(57) ABSTRACT

A battery charger is disclosed to includes a power supply unit for converting AC power supply into DC power supply, and a charging unit, which is detachably connected to the power supply unit and adjustable through a rotary knob to change the length of the battery chambers thereof to fit different sizes of battery cells to be charged by the charging unit.

### BACKGROUND OF THE INVENTION

1. Field of the Invention

The present invention relates to battery chargers and more particularly, to such a battery charger that is adjustable to fit different sizes of battery cells.

2. Description of the Related Art

A conventional battery charger comprises a power circuit unit for converting AC power supply into DC power supply, and a charging circuit unit for charging inserted battery with output DC power supply from the power circuit unit. This design of battery charger does not provide any added function. Further, this design of battery charger can only charge a specific size of battery cells.

### SUMMARY OF THE INVENTION

The present invention has been accomplished under the circumstances in view. It is therefore the main object of the present invention to provide a battery charger, which is adjustable to fit different sizes of battery cells. It is another object of the present invention to provide a battery charger, which provides an added illumination function. According to one aspect of the present invention, the battery charger comprises a power supply unit for converting AC power supply into DC power supply, and a charging unit, which is detachably connected to the power supply unit and adjustable through a rotary knob to change the length of the battery chambers thereof to fit different sizes of battery cells to be charged by the charging unit. According to another aspect of the present invention, the power supply unit has a plurality of light emitting diodes for giving off light for illumination, and a lens through which the light of the light emitting diodes passes to the outside for illumination.

### BRIEF DESCRIPTION OF THE DRAWINGS

FIG. 1 is an exploded view of a battery charger according to the present invention.

FIG. 2 shows the power supply unit and the charging unit respectively assembled before insertion of the charging unit into the top accommodation open chamber of the power supply unit according to the present invention.

FIG. 3 corresponds to FIG. 2, showing the charging unit inserted into the top accommodation open chamber of the power supply unit.

FIG. 4 is a side view in section of the battery charger according to the present invention.

FIG. 5 is similar to FIG. 4 but showing the pitch between the metal contact members of the locating plate and the metal contact members of the slide adjusted.

FIG. 6 is a circuit diagram of the circuit board of the charging unit.

### DETAILED DESCRIPTION OF THE PREFERRED EMBODIMENT

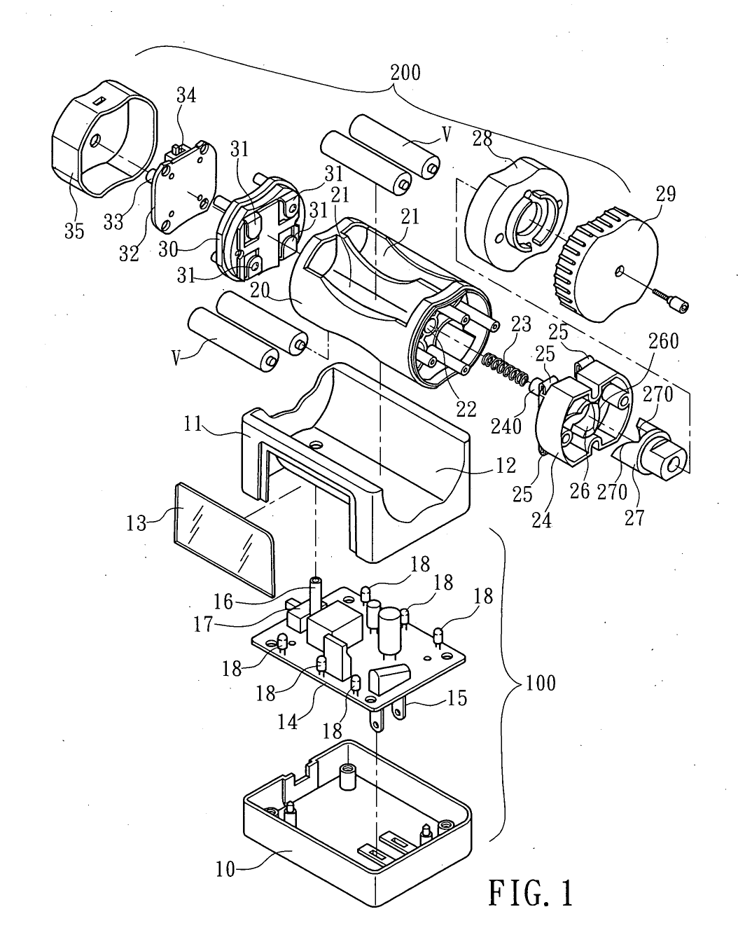

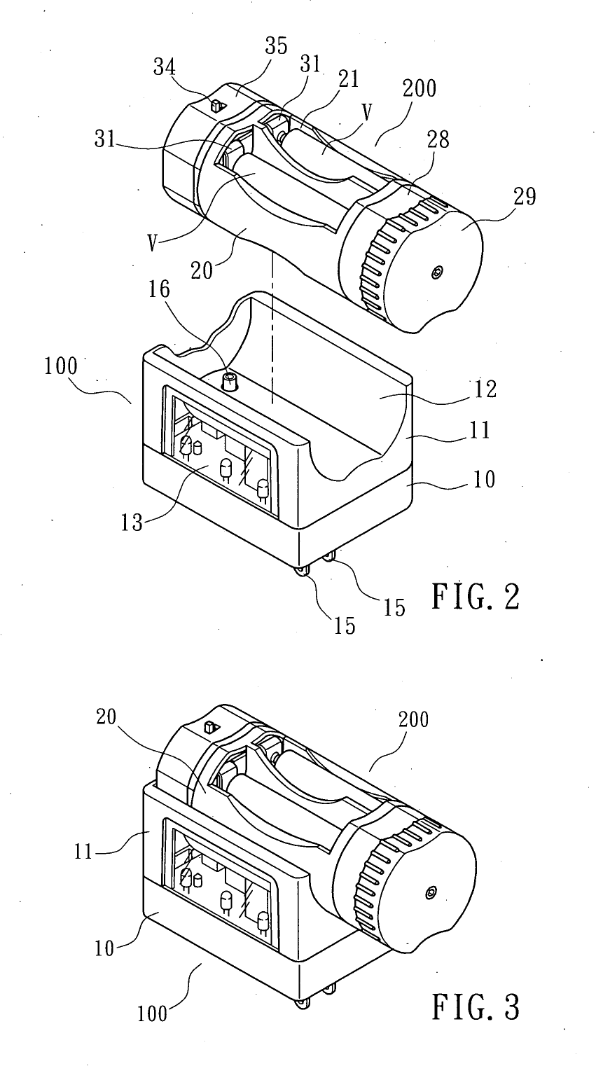

Referring to FIGS. 1˜5, a battery charger in accordance with the present invention is shown comprised of a power supply unit 100, and a charging unit 200.

The power supply unit 100 comprises a casing 10, a circuit board 14 mounted inside the casing 10, and a cover shell 11 covering the casing 10. The circuit board 14 has metal blades 15 extending out of the casing 10 for insertion into an AC outlet to receive city power supply for conversion into DC power supply by the circuit board 14, an electric output connector 16 for DC output, a switch 17 for switching on/off the electric output connector 16, and a plurality of LEDs (light emitting diodes) 18. The cover shell 11 has a lens 13 through which the light of the LEDs 18 pass to the outside of the power supply unit 100 for illumination, and a top accommodation open chamber 12 adapted to accommodate the charging unit 200.

The charging unit 200 comprises a battery holder 20, which has a plurality of battery chambers 21 for holding battery cells V and a sliding hole 22 axially disposed in one end, a locating plate 30, which is fastened to one end of the battery holder 20 opposite to the sliding hole 22 and has a plurality of metal contact members 31 respectively disposed in contact with one terminal of each battery cell V installed in the battery chambers 21, a circuit board 32, which is mounted on the locating plate 30 and has an electric output connector 33 for DC output and a selector switch 34 for switching on/off the electric output connector 33 between a first position to provide power supply to an external electric apparatus and a second position to charge the battery cells V; when switching on the electric output connector 33, the charging unit 200 works to provide power supply to an external electric apparatus), a cap 35 capped on one end of the battery holder 20 and covered over the locating plate 30 and the circuit board 32, a spring member 23 mounted inside the sliding hole 22 of the battery holder 20, a slide 24 axially slidably coupled to the battery holder 20, an actuating member 27, a cover shell 28, and a rotary knob 29. The slide 24 has a plurality of metal contact members 25 for contacting the other terminal of each battery cell V installed in the battery chambers 21, a projecting guide bar 26, which has a beveled guide face 260, and a coupling rod 240 and slidably inserted into the sliding hole 22 of the battery holder 20 and stopped against the spring member 23. The cover shell 28 is capped on one end of the battery holder 20 opposite to the cap 35 to hold the actuating member 27 in place. The actuating member 27 is inserted through the cover shell 28 and affixed to the rotary knob 29, having two beveled guide faces 270 selectively disposed in contact with the beveled guide face 260 of the projecting guide bar 26. When rotating the rotary knob 29, the actuating member 27 is rotated with the rotary knob 29 to move the associating beveled guide face 270 against the beveled guide face 260 of the projecting guide bar 26, thereby adjusting the pitch between the metal contact members 31 of the locating plate 30 and the metal contact members 25 of the slide 24 subject to the size (length) of the battery cells V that are installed in the battery chambers 21.

When the charging unit 200 is inserted into the top accommodation open chamber 12 of the cover shell 11 of the power supply unit 100, the circuit board 32 is electrically connected to the electric output connector 16 of the circuit board 14.

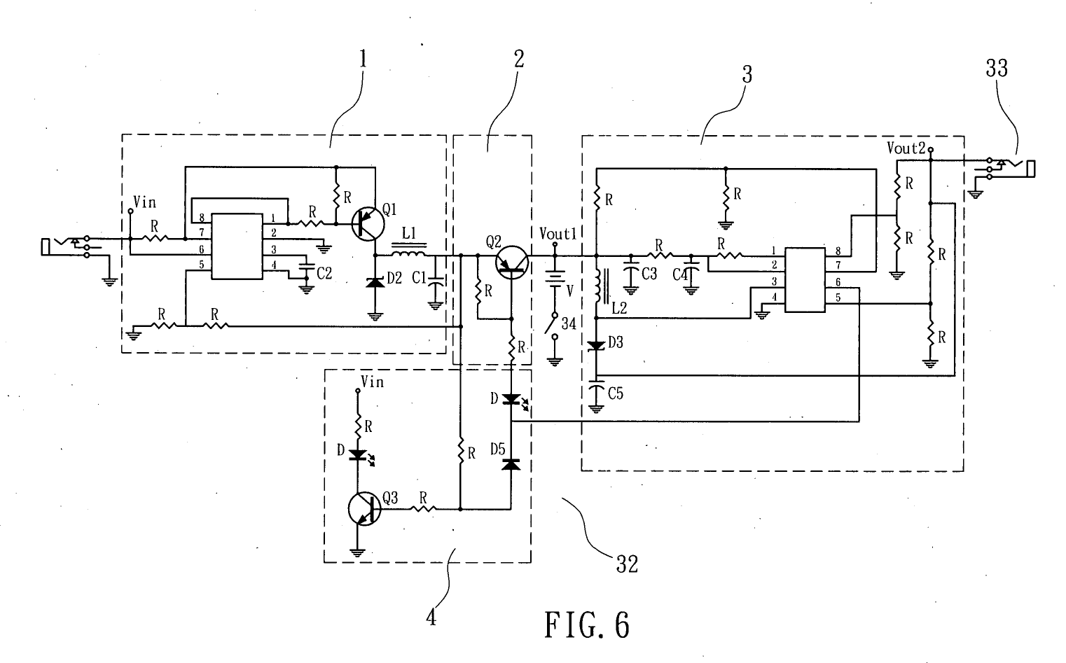

Referring to FIG. 6, the circuit board 32 of the charging unit 200 comprises a voltage dropping circuit 1, adapted to drop the voltage of the output power supply of the power supply unit 100 into a predetermined charging voltage for charging the battery cells V that are mounted in the battery chambers 21 of the battery holder 20, a protection circuit 2 comprised of a transistor Q2 and electrically connected to the output end of the voltage dropping circuit 1 for cutting off the circuit when the voltage passing out of the voltage dropping circuit 1 into the protection circuit 2 is abnormal (surpassed a predetermined voltage level), a booster circuit 3 electrically connected to the output end of the protection circuit 2 to boost the voltage of output power outputted from the protection circuit 2 for supply to an external electric apparatus through the electric output connector 33 of the circuit board 30 of the charging unit 200 when the switch 34 is switched to the first position (switched on the electric output connector 33), and a charging indicator circuit 4 comprised of a transistor Q3 and a LED D. During a charging operation of the battery charger, the transistor Q3 is electrically connected to turn on the LED D, giving a signal indicative of the charging operation.

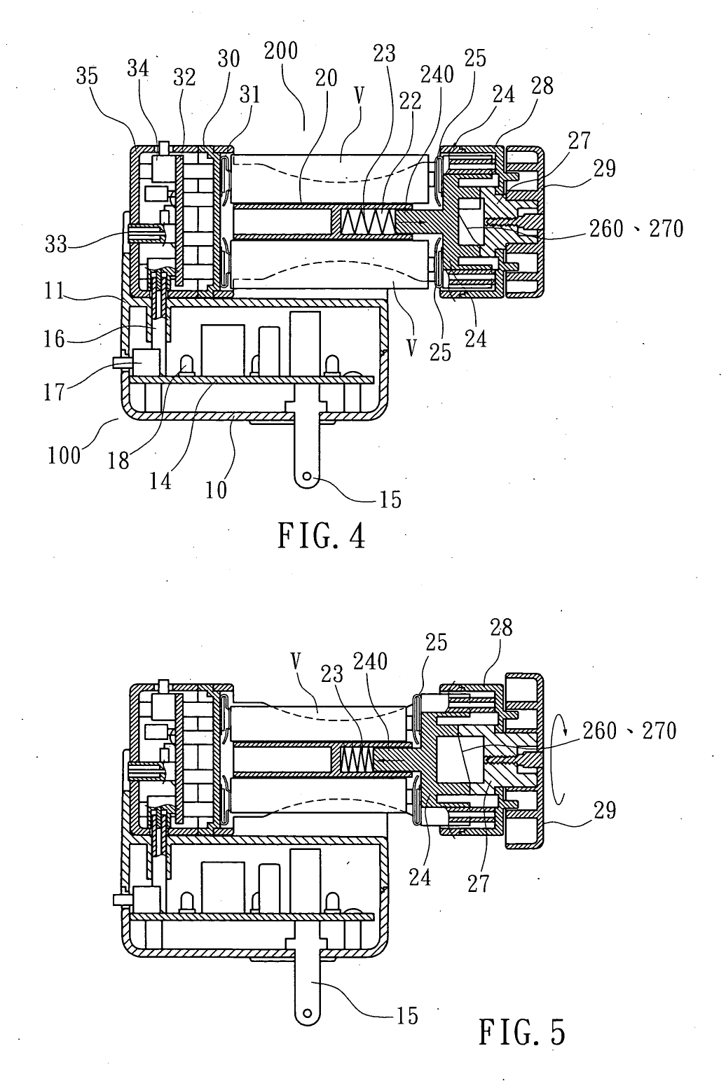

Referring to FIGS. 3 and 4 again, when the switch 34 is switched to the second position (switched off the electric output connector 33) after connection of the metal blades 15 to an electric outlet, the circuit board 14 of the power supply unit 100 converts AC power supply into DC power supply for the circuit board 32 of the charging unit 200 to charge the battery cells V that are inserted into the battery chambers 21 of the battery holder 20.

Referring to FIGS. 4 and 5 again, the user can rotate the rotary knob 29 to force the actuating member 27 to move the slide 24, thereby adjusting the pitch between the metal contact members 31 of the locating plate 30 and the metal contact members 25 of the slide 24 subject to the size (length) of the battery cells V that are installed in the battery chambers 21.

A prototype of battery charger has been constructed with the features of FIGS. 1˜6. The battery charger functions smoothly to provide all of the features discussed earlier.

Although a particular embodiment of the inventions has been described in detail for purposes of illustration, various modifications and enhancements may be made without departing from the spirit and scope of the invention. Accordingly, the invention is not to be limited except as by the appended claims.

What the invention claimed is:

1. A battery charger comprising a charging unit for charging battery cells, said charging unit comprising a battery holder, which has a plurality of battery chambers for holding battery cells and a sliding hole axially disposed in one end thereof, a locating plate, which is fastened to one end of said battery holder opposite to said sliding hole and has a plurality of metal contact members for the contact of a one terminal of each battery cell being inserted into said battery chambers, a circuit board mounted on said locating plate, a cap capped on one end of said battery holder and covered over said locating plate and the circuit board of said charging unit, a spring member mounted inside said sliding hole of said battery holder, a slide axially slidably coupled to said battery holder, an actuating member, a cover shell, and a knob, said slide having a plurality of metal contact members for contacting a second terminal of each battery cell installed in said battery chambers, a projecting guide bar, which has a beveled guide face, and a coupling rod slidably inserted into said sliding hole of said battery holder and stopped against said spring member, the cover shell of said charging unit being capped on one end of said battery holder opposite to said cap to hold said actuating member in place, said actuating member being inserted through said cover shell and affixed to said rotary knob, said actuating member having two beveled guide faces selectively disposed in contact with the beveled guide face of said projecting guide bar for moving said slide axially relative to said battery holder upon rotation of said rotary knob.

2. The battery charger as claimed in claim 1, further comprising a power supply unit adapted to provide power supply to said charging unit, said power supply unit comprising a casing, a circuit board mounted inside said casing and adapted to convert AC power supply into DC power supply, and a cover shell covering said casing, the circuit board of said power supply unit comprising a plurality of metal blades extending out of said casing for insertion into an AC outlet for input of AC power supply and an electric output connector for DC output and an electric output connector, said cover shell having a top accommodation open chamber adapted to accommodate said charging unit and to have the circuit board of said charging unit be electrically connected to the electric output connector of the circuit board of said power supply unit.

3. The battery charger as claimed in claim 1, wherein the circuit board of said charging unit comprises a voltage dropping circuit adapted to drop the voltage of the output power supply of said power supply unit to a predetermined charging voltage for charging the battery cells that are inserted into said battery chambers of said battery holder, a protection circuit comprised of a transistor and electrically connected to said voltage dropping circuit for cutting off the circuit when the voltage passing out of said voltage dropping circuit surpassed a predetermined voltage level, a booster circuit electrically connected to an output end of said protection circuit to boost the voltage of output power outputted from said protection circuit for supply to an external electric apparatus, and a charging indicator circuit comprised of a transistor and an indicator light for turning on said indicator light during a charging operation of said charging unit.
